(19) United States
(12) Patent Application Publication
(10) Pub. No.: US 2010/0045634 A1
(43) Pub. Date: Feb. 25, 2010

(54) OPTICAL DIODE LASER TOUCH-CONTROL DEVICE

(75) Inventors: SHENG-PIN SU, Tao-Yuan (TW); TSAI-KUEI WEI, Hsinchu County (TW)

Correspondence Address: STOUT, UXA, BUYAN & MULLINS LLP, 4 VENTURE, SUITE 300, IRVINE, CA, 92618, US

(73) Assignee: TPK TOUCH SOLUTIONS INC., TAIPEI CITY (TW)

(21) Appl. No.: 12/544,607

(22) Filed: Aug. 20, 2009

(30) Foreign Application Priority Data
Aug. 21, 2008 (TW) 097131865

(51) Int. Cl. G06F 3/042

(52) U.S. Cl. 345/175

(57) ABSTRACT

An optical diode laser touch-control device includes two light emitters and a plurality of receivers around a touch-acting area of a touch panel. The light emitters are disposed on two adjacent corners of the touch panel in the touch-acting area, and each employs a diode laser to continuously project a diffused light through a lens for covering the touch-acting area to form an interlaced touch screen. The receivers, which are capable of receiving the diffused light, are disposed on the touch panel around the touch-acting area to receive the diffused light. As a finger touches the touch-acting area of the touch panel, a part of the diffused light is blocked from being projected onto the receivers, and the touch position of the touch-acting area may be calculated accordingly.

### CROSS-REFERENCE TO RELATED APPLICATIONS

The entire contents of Taiwan Patent Application No. 097131865, filed on Aug. 21, 2008, from which this application claims priority, are incorporated herein by reference.

### BACKGROUND OF THE INVENTION

1. Field of the Invention

The present invention relates to touch panels, and more particularly to optical touch-control devices combining diode lasers and triangulation methods for detecting touch positions on touch panels.

2. Description of the Related Art

Input modes of conventional touch panels include a resistive mode, a capacitive mode, an optical mode, and others. The resistive mode and the capacitive mode are performed by touching the surface of the touch panel with a finger to effectuate a change of the voltage and current at the touch position of the touch panel thereby enabling detection of the touch position on the touch panel.

However, in a conventional touch panel employing the resistive or capacitive input mode, the touch-control structure consists of a number of thin-film layers, and the transparent capabilities (such as the transparency, the color distortion, the reflective property, the resolution, etc.) of the thin-film layers can affect the visual effect of the touch panel. Such conventional touch panels employing the resistive or capacitive touch-control input modes inevitably reduce rather than enhance the visual effect (e.g., appearance to a user) thereby causing a commensurate reduction in usability. Furthermore, the surface of the touch panel must be touched or even pressed by the finger of a user to ensure a proper input effect. This requirement commonly results in surface scratches and damage, resulting in the transparent capabilities of the touch panel being adversely impacted at the expense of usability of the device.

Conventional touch panels employing the optical input mode use light to detect the touch position on the surface of the touch panel, which is touched by the finger. Accordingly, this will not impact the transparency capabilities of the touch panel and will achieve a better visual effect than touch panels employing resistive or capacitive touch-control input modes. Implementations of the optical input mode include the triangulation method (for example, as disclosed in US Patent Publication No. 2001/0055006A1), the optical distance time difference measuring method (for example, as disclosed in U.S. Pat. No. 5,196,835 and China Patent Publication No. CN1568452A), the on-off directly reading method (for example, as disclosed in U.S. Pat. No. 7,133,031 and China Patent Application No. 200510097130.2), and the image interpretation method (for example, as disclosed in US Patent Publication No. 2005/0275618 and U.S. Pat. No. 7,242,388).

For the above triangulation method, the touch-control technology disclosed in the US Patent Publication No. 2001/0055006A1 mainly employs an actuator (motor and/or oscillator) to continuously rotate or oscillate a polygon mirror for reflecting the focused light emitted from a diode laser, such that several reflective materials about the periphery of the touch panel are scanned, and the light reflected by the reflective materials is indirectly received by a photo-detector, which is integrated with the diode laser in a module, to detect the touch position of the surface of the touch panel. However, a disadvantage of this structure is that electromagnetic waves generated by the motor and oscillator can greatly interfere with the communication quality of electrical products using the touch panel. Furthermore, the bulk and the power consumption of the motor and the oscillator are not small, thus disadvantageously reducing the capability for light-weight and energy-saving designs of the products. In addition, since the diode laser and the photo-detector are integrated in the same module, the photo-detector only can receive the light reflected by the reflective materials at particular angles. Thus, with the amount of received light being insufficient, the signal-to-noise ratio, too, is bad and should be improved.

A need has thus arisen to propose a novel optical diode laser touch-control device for overcoming the disadvantages mentioned above.

### SUMMARY OF THE INVENTION

To solve the above problems plaguing the prior art, the present invention provides an optical diode laser touch-control device, particularly one that employs continuous interlaced light and ways of directly sensing the interlaced light to perform touch detection and determine touch position using the triangulation method, for facilitating light-weight and energy-saving designs of electrical products.

According to one embodiment, an optical diode laser touch-control device includes a touch panel, at least two light emitters, and a number of receivers. The touch panel has a touch-acting area, and the two light emitters are disposed on two adjacent corners of the touch panel respectively. Each light emitter includes a diode laser and a lens. The diode laser is integrated in the corresponding light emitter by a semiconductor packaging technology, and the lens is integrated in the corresponding light emitter by the semiconductor packaging technology and arranged between the diode laser and the touch-acting area. The light is emitted continuously from the diode laser and is refracted by the lens to continuously emit a diffused light to cover the touch-acting area for forming an interlaced touch screen. The receivers, which are capable of receiving the diffused light, are disposed on the touch panel around the touch-acting area to receive the diffused light.

### BRIEF DESCRIPTION OF THE DRAWINGS

Many aspects of the embodiments can be better understood with reference to the following drawings. The components in the drawings are not necessarily to scale, emphasis instead being placed upon clearly illustrating the principles of the present disclosures. Moreover, in the drawings, like reference numerals designate corresponding parts throughout the several views.

FIG. 1 is a schematic top view showing an optical diode laser touch-control device according to a preferred embodiment of the present invention;

FIG. 2 is a schematic side view of the optical diode laser touch-control device of the embodiment;

FIG. 3 is a schematic detailed view of the light emitter of the embodiment;

FIG. 4 is a cross-sectional view of the light emitter according to another embodiment;

FIG. 5 is a perspective view of a lens of the embodiment;

FIG. 6 is a schematic view showing diffused lights from the lens of FIG. 5 projecting on the receivers to result in a straight line;

FIG. 7 is a schematic top view showing a finger touching the touch-acting area of the present embodiment to block the diffused light;

FIG. 8 is a schematic side view showing a finger touching the touch-acting area of the present embodiment to shade the diffused light;

FIG. 9 is a perspective view of the lens according to another embodiment;

FIG. 10 is a schematic view showing the diffused lights from the lens of FIG. 9 projecting on the receivers to result in a dashed line;

FIG. 11 is a perspective view of the lens according to a further embodiment; and

FIG. 12 is a schematic view showing the diffused lights from the lens of FIG. 11 projecting on the receivers to result in a dotted line.

### DETAILED DESCRIPTION OF THE INVENTION

Reference will now be made to the drawings to describe exemplary embodiments of the present optical diode laser touch-control device, in detail. The following description is given by way of example, and not limitation.

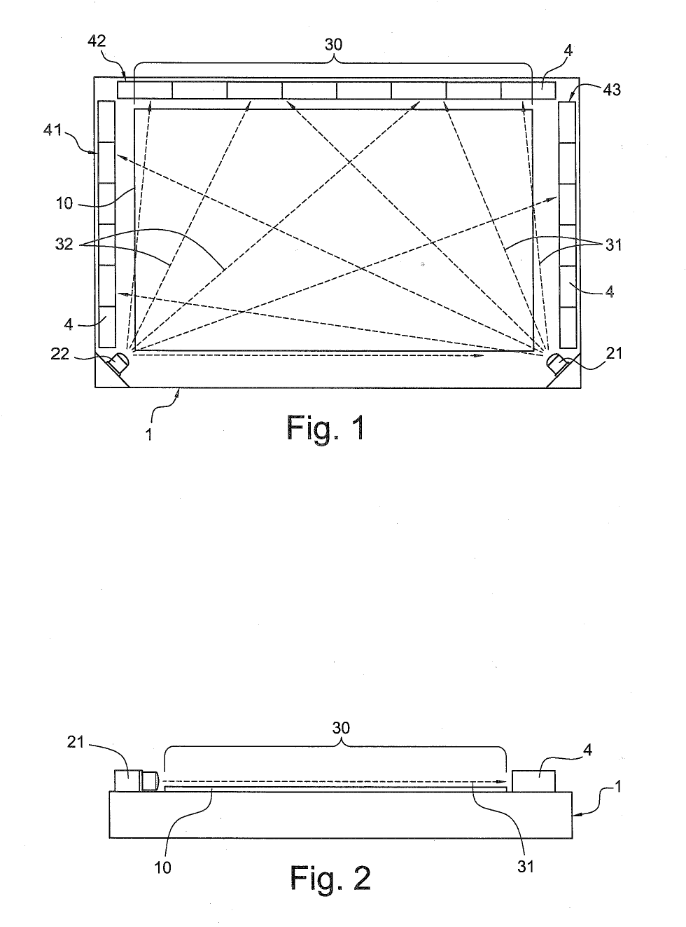

FIG. 1 is a schematic top view showing an optical diode laser touch-control device according to a preferred embodiment of the present invention, and FIG. 2 is a schematic side view of the optical diode laser touch-control device of the embodiment. The optical diode laser touch-control device includes a touch panel 1, a first light emitter 21, a second light emitter 22, and a plurality of receivers 4. A touch-acting area 10 is defined on a surface of the touch panel 1. The first and second light emitters 21, 22 are disposed in proximity to (e.g., on or at) two adjacent corners of the touch panel 1 respectively, and are configured for continuously emitting a diffused light 31, 32 (also shown in FIG. 6) respectively to cover (e.g., entirely cover) the area above the surface of the touch-acting area 10, such that the diffused light 31, 32 emitted from the first and second light emitters 21, 22 forms an interlaced touch screen 30 above the surface of the touch-acting area 10. The receivers 4, which are provided to be capable of receiving (e.g., capturing for processing) the diffused light 31, 32 are respectively disposed on the surface of the touch panel 1 along the periphery of the touch-acting area 10 to encounter (e.g., receive) the diffused light 31, 32.

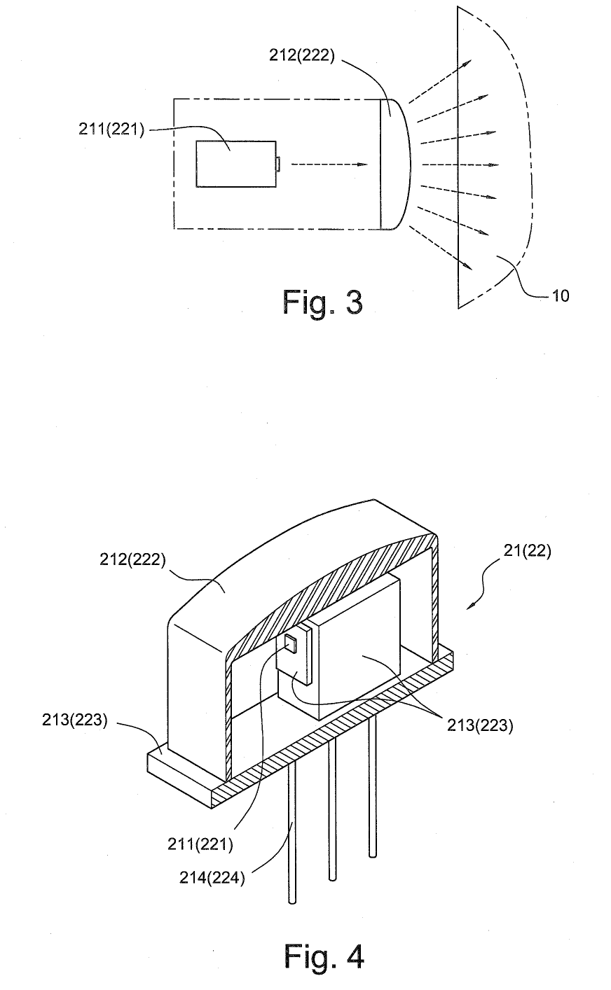

FIG. 3 is a schematic detailed view of the first and second light emitters 21, 22 of the present embodiment. In the embodiment, each of the first and second light emitters 21, 22 includes a diode laser 211, 221 and a lens 212, 222. The lens 212 is arranged between the diode laser 211 and the touch-acting area 10, and is integrated with the diode laser 211 by a semiconductor packaging technology, such as discussed above and such that the lens 212 is packaged near a front end of the diode laser 211. Furthermore, the dot-shaped focused light emitted continuously from the diode laser 211 can be refracted by lens 212 to continuously emit the diffused light 31. Similarly, the lens 222 is also arranged between the diode laser 221 and the touch-acting area 10, and is integrated with the diode laser 221 by the semiconductor packaging technology, such that the lens 222 is packaged near a front end of the diode laser 221. Furthermore, the dot-shaped focused light emitted continuously from the diode laser 221 can be refracted by lens 222 to continuously emit the diffused light 32.

In the embodiment, angles between the projection directions of the light emitted from the first light emitter 21 and the boundary of the touch-acting area 10 is about 10-80 degrees as shown in FIG. 1. Angles between the projection directions of the light emitted from the second light emitter 22 and the boundary of the touch-acting area 10 is also about 10-80 degrees. In a preferable embodiment, angles between the light emitters 21, 22 and the boundary of the touch-acting area 10 respectively are about 45 degrees.

FIG. 4 is a cross-sectional view of the light emitter according to another embodiment. The diode laser 211 is integrated in the first light emitter 21 by the semiconductor packaging technology. The lens 212 is also integrated in the first light emitter 21 by the semiconductor packaging technology. Furthermore, a heat sink 213 and a plurality of pins 214 are arranged on the bottom of the first light emitter 21. The diode laser 221 is integrated in the second light emitter 22 by the semiconductor packaging technology. The lens 222 is also integrated in the second light emitter 22 by the semiconductor packaging technology. Furthermore, a heat sink 223 and a plurality of pins 224 are arranged on the bottom of the second light emitter 22.

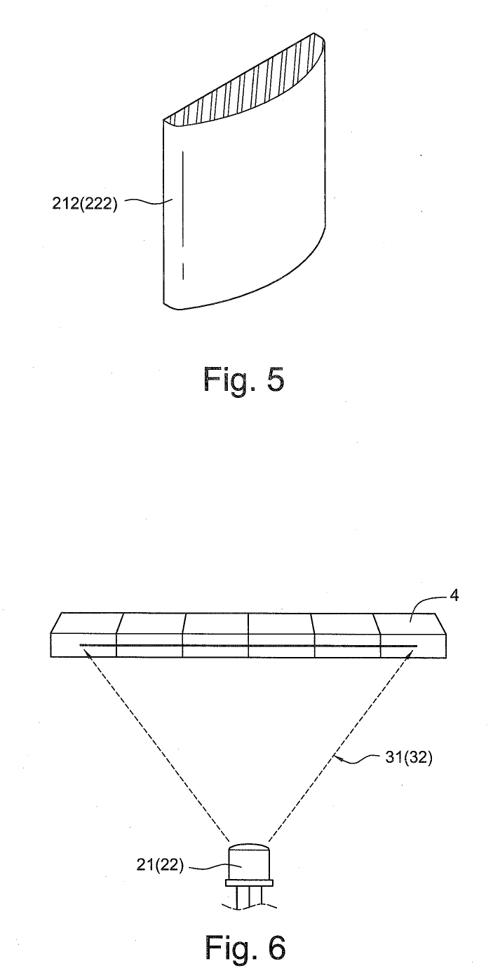

The cross sections of the lenses 212, 222 of the first and second light emitters 21, 22 represent a cambered profile (as shown in FIG. 5), such that the diffused light 31, 32 emitted from the first and second light emitters 21, 22 projecting on the receivers 4 results in a straight line (as shown in FIG. 6).

The diffused light 31, 32 may be invisible light, such as one or more of infrared light and ultraviolet light, etc. Furthermore, the receivers 4 are arranged around the touch-acting area 10 in a U shape (as shown in FIG. 1), such that a first receiving area 41, a second receiving area 42, and a third receiving area 43 are formed in the periphery of the touch-acting area 10 in sequence. The diffused light 31 of the first light emitter 21 may be projected on the first receiving area 41 and the second receiving area 42, and the diffused light 32 of the second light emitter 22 may be projected on the second receiving area 42 and the third receiving area 43.

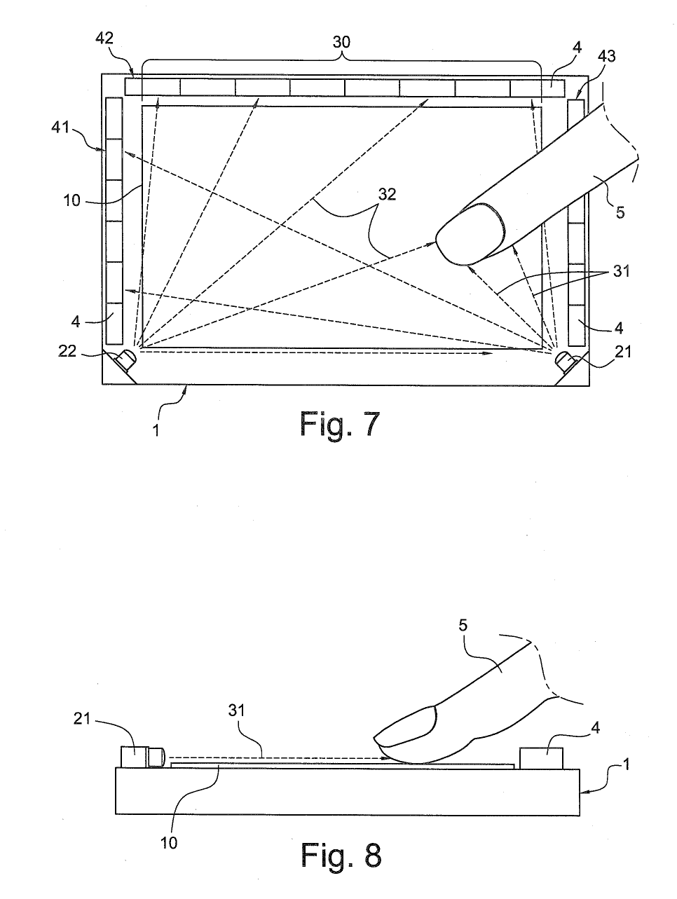

The present embodiment may be performed by a combination of the above elements. Specifically, when the finger 5 of the user touches the touch-acting area 10 of the touch panel 1 (as shown in FIGS. 7 and 8), the finger 5 will penetrate through the touch screen 30 to prevent a part of the light 31 from projecting to the first receiving area 41 and/or the second receiving area 42, and prevent a part of the light 32 from projecting to the second receiving area 42 and/or the third receiving area 43. Accordingly, the receivers 4 generate a signal related to two changes of light shadow, and output the signal to an outside signal processor (not shown), followed by calculation using the triangulation method to determine the touch position of the surface of the touch-acting area 10 of the touch panel 1 for performing the touch-control operation.

According to the embodiment discussed above, the diode lasers 211, 221 and the lenses 212, 222 are packaged or integrated into the respective light emitters 21, 22, which are then used as the light sources for directly emitting the diffused light 31, 32 to cover the touch-acting area 10. Thus the present embodiment can omit the motor and the oscillator of the prior art to ensure or enhance communication quality of the products, and can reduce the volume of the diode lasers 211, 221 and the lenses 212, 222 to facilitate light-weight and energy-saving designs of the electrical products. Simultaneously, the present embodiment employs the receivers 4 to directly sense the change of the light 31, 32 to replace the reflective materials of the prior art, such that the input sense resolution of the touch panel may be improved.

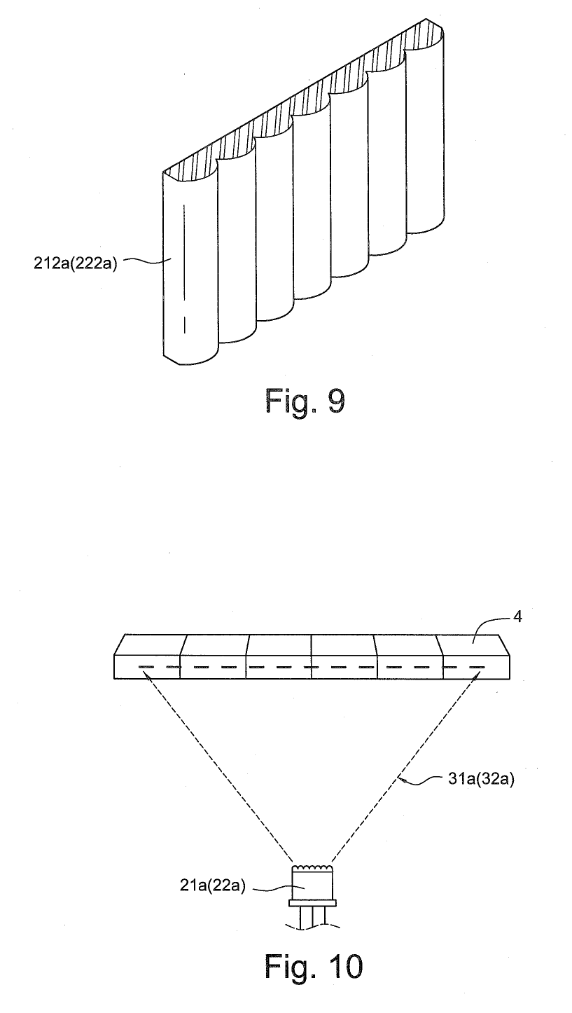

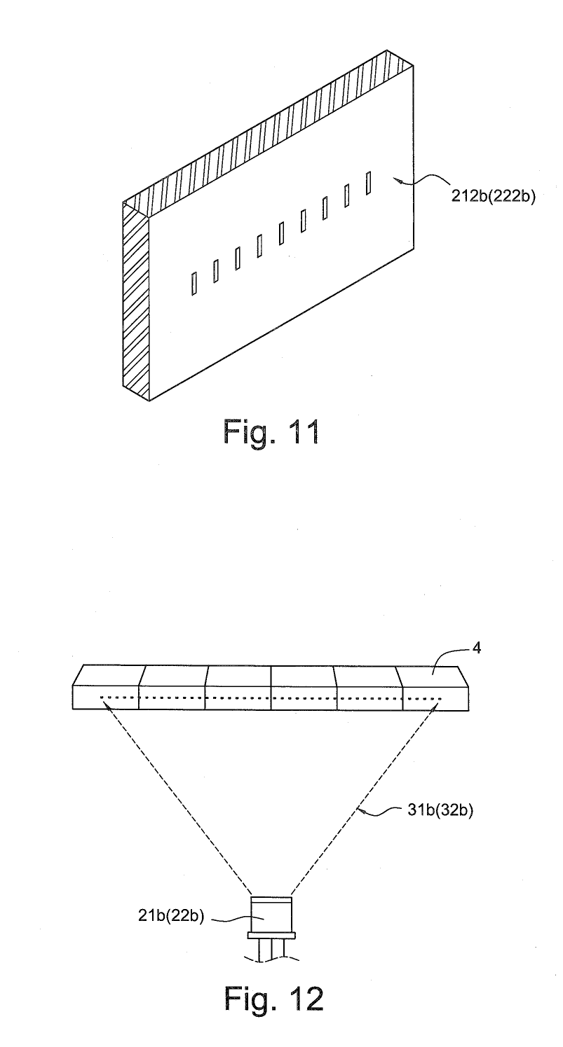

FIG. 9 is a perspective view of the lens according to another embodiment. The cross sections of the lenses 212a, 222a of the first and second light emitters 21a, 22a may represent a plurality of cambered profiles in sequence, such that the diffused light 31a, 32a emitted from the first and second light emitters 21a, 22a projecting on the receivers 4 results in a dashed line (as shown in FIG. 10). The other elements and the implemental mode are similar to those of the previous embodiment. Alternatively, as shown in FIG. 11, the lenses 212b, 222b of the first and second light emitters 21b, 22b may be a Fresnel lens, which is an imaging lens configured for generating Moiré patterns, such that the diffused light 31b, 32b emitted from the first and second light emitters 21b, 22b projecting on the receivers 4 results in a dotted line (as shown in FIG. 12). The other elements and the implemental mode are similar to those of the previous embodiment.

Given the above disclosure, one skilled in the art could devise variations that are within the scope and spirit of the invention disclosed and referenced herein, including modifications to configurations, ways, materials, and/or designs. Further, the various features of the embodiments disclosed and referenced herein can be used alone, or in varying combinations and permutations with each other, to the extent not mutually exclusive, and are not intended to be limited to the specific combinations described herein. Thus, the scope of the claims is not to be limited by the illustrated embodiments.

What is claimed is:

1. An optical diode laser touch-control device, comprising:
a touch panel having a touch-acting area;
two light emitters disposed on two adjacent corners of the touch panel respectively, each said light emitter comprising:
a diode laser integrated in the corresponding light emitter by a semiconductor packaging technology; and
a lens integrated in the corresponding light emitter by the semiconductor packaging technology and being arranged between the diode laser and the touch-acting area, light emitted continuously from the diode laser being refracted by the lens to emit a diffused light to cover the touch-acting area for forming an interlaced touch screen; and
a plurality of receivers, which are capable of receiving the diffused light and disposed on the touch panel around the touch-acting area to receive the diffused light.

2. The device as set forth in claim 1, wherein a cross section of the lens represents a cambered profile to make the diffused light a straight line.

3. The device as set forth in claim 1, wherein a cross section of the lens represents a plurality of cambered profiles to make the diffused light a dashed line.

4. The device as set forth in claim 1, wherein the lens is a Fresnel lens to make the diffused light a dotted line.

5. The device as set forth in claim 1, wherein the diffused light is invisible light comprising infrared light or ultraviolet light.

6. The device as set forth in claim 1, wherein the receivers are arranged around the touch-acting area in a U shape.

7. The device as set forth in claim 1, wherein light emitted continuously from the diode lasers is refracted by the lenses to emit a diffused light to cover entirely the touch-acting area for forming an interlaced touch screen.

8. An optical diode laser touch-control device, comprising:
a touch panel having a touch-acting area;
two diode lasers disposed on two adjacent corners of the touch panel respectively; and
two lenses, each being arranged between one of the diode lasers and the touch-acting area respectively and being integrated with the diode laser by a semiconductor packaging technology, light emitted continuously from the diode laser being refracted by the lens to emit a diffused light to cover the touch-acting area for forming an interlaced touch screen.

9. The device as set forth in claim 8, further comprising a plurality of receivers, which are capable of capturing the diffused light for processing, disposed on the touch panel around the touch-acting area to receive the diffused light.

10. The device as set forth in claim 8, wherein a cross section of the lens represents a cambered profile to make the diffused light a straight line.

11. The device as set forth in claim 8, wherein a cross section of the lens represents a plurality of cambered profiles to make the diffused light a dashed line.

12. The device as set forth in claim 8, wherein the lens is a Fresnel lens to make the diffused light a dotted line.

13. The device as set forth in claim 8, wherein the diffused light is invisible light comprising one or more of infrared light and ultraviolet light.

14. The device as set forth in claim 8, wherein the receivers are arranged around the touch-acting area in a U shape.

15. An optical diode laser touch-control device, comprising:
a touch panel having a touch-acting area;
two light emitters disposed in proximity to two adjacent corners of the touch panel respectively, each continuously emitting a diffused light to cover the touch-acting area for forming an interlaced touch screen; and
a plurality of receivers disposed on the touch panel around the touch-acting area to receive the diffused light.

16. The device as set forth in claim 15, wherein the diffused light represents a straight line, a dashed line or a dotted line.

17. The device as set forth in claim 15, wherein the diffused light is invisible light comprising infrared light or ultraviolet light.

18. The device as set forth in claim 15, wherein the receivers are arranged around the touch-acting area in a U shape.

19. The device as set forth in claim 15, the two light emitters being disposed on two adjacent corners of the touch panel.

20. The device as set forth in claim 15, further comprising a signal processor, whereby each of the receivers is capable of capturing the diffused light and converting it to a signal suitable for performance of a calculation by the signal processor using a triangulation method.
